(19) United States
(12) Patent Application Publication
(10) Pub. No.: US 2020/0026299 A1
(43) Pub. Date: Jan. 23, 2020

(54) Method for Operating a Highly Automated or Fully Automated Vehicle

(71) Applicant: Robert Bosch GmbH, Stuttgart (DE)

(72) Inventor: Holger Mielenz, Ostfildern (DE)

(21) Appl. No.: 16/442,757

(22) Filed: Jun. 17, 2019

(30) Foreign Application Priority Data
Jul. 20, 2018 (DE) 10 2018 212 112.5

(51) Int. Cl. G05D 1/02; B60T 7/12

(52) U.S. Cl. CPC G05D 1/0214; G05D 2201/0213; B60T 7/12

(57) ABSTRACT

A method for operating an automated vehicle includes receiving environment data and determining and/or detecting a fire based on the environment data. The method further includes determining a distance of the fire from a road to be traveled by the vehicle and/or from a planned trajectory of the vehicle. The method further includes determining a danger level posed by the fire to the vehicle occupants based on the determined distance and providing an output signal for operating the vehicle based on the determined danger level.

This application claims priority under 35 U.S.C. § 119 to patent application no. DE 102018212112.5 filed on Jul. 20, 2018 in Germany, the disclosure of which is incorporated herein by reference in its entirety.

The disclosure relates to a method for operating an automated vehicle, to a device designed to perform said method, to a computer program for performing said method, and to a machine-readable storage medium, on which said computer program is stored.

### BACKGROUND

The prior art discloses methods for identifying hazardous situations, for instance a fire.

For example, DE 10 2015 202 930 A1 discloses a method for reporting an obstacle. The method includes a step of importing at least one piece of information about an obstacle in a route segment of a route to be traveled by a vehicle, and a step of providing the information to an interface of an information device in order to report the obstacle.

### SUMMARY

The disclosure describes a method for operating an automated vehicle, comprising the steps: receiving environment data, ascertaining and/or detecting a fire on the basis of the environment data, ascertaining a distance of the fire from a road to be traveled by the vehicle and/or from a planned trajectory of the vehicle, determining a danger level posed by the fire to the vehicle occupants on the basis of the ascertained distance, in particular on the basis of the ascertained distance and the ascertained or detected fire, and outputting a signal for operating the vehicle on the basis of the determined danger level.

The automated vehicle may be a vehicle that is operated in an assisted, partially automated, highly automated or fully automated manner. The vehicle is preferably under highly automated or fully automated control and can also be operated entirely without any intervention by a driver.

The received environment data may be, for example, data about the vehicle environment, which data has been recorded using a sensor. The sensors may be in-vehicle sensors, for instance, such as video sensors, radar, lidar sensors and/or ultrasonic sensors, for example. The data may also be acoustic data from microphones. In particular, it may be data from a camera that has a high sensitivity in the infrared region, in particular in the far infrared region. It may also be the case that the sensors are mounted on other vehicles or on infrastructure equipment.

In addition, the received environment data may also be pre-analyzed data from other vehicles and/or from an external server. For example, on a server, a plurality of data received by this server and indicative of a fire may already have been aggregated and analyzed. This information about the fire and the position thereof can hence be sent to the vehicle, which can receive this information in the form of environment data.

Depending on the received environment data, a fire is ascertained or detected on the basis of this environment data. If the environment data is sensor data or incompletely analyzed information, it is ascertained whether there is a fire. If the environment data is already fully analyzed data, and if this data contains the information as to whether a fire exists, and if so, where this fire exists, it is possible just to detect a fire on the basis of this environment data.

Ascertaining a distance of the fire can involve determining the distance between the fire and a road to be traveled by the vehicle. The road to be traveled by the vehicle may be in particular a road that has been selected as a convenient road for reaching a predefined destination. In particular, it is the road already being traveled by the vehicle, i.e. the road on which the vehicle is currently located and which is deemed passable. In particular, the side to be traveled on the road can be taken into account in determining the distance.

Alternatively or additionally, the distance can be derived also on the basis of a trajectory planned by the vehicle. In this case, a plurality of possible trajectories can also be used for determining the distance. If the vehicle is under automated control, the information about these trajectories may already exist in a control unit of the vehicle.

Determining a danger level posed by the fire to the vehicle occupants is performed on the basis of the ascertained distance. In particular, the ascertained fire and, if applicable, the properties thereof, influence this ascertainment. Properties may be, for example, the size of the fire, information about the type of the burning object, the temperature of the fire, or further information which has been received from an external server, for instance. In particular, it can be decided on the basis of the determined danger level whether the vehicle can pass the fire on the road to be traveled without endangering the vehicle occupants.

A signal for operating the vehicle is output on the basis of the determined danger level. This signal can be transmitted, for example, to another on-board unit such as a control unit of the vehicle, and can be processed further there for the purpose of operating the vehicle. The signal is used in particular to control the vehicle, in particular to bring about transverse and longitudinal guidance of the vehicle. The outputting of the signal is used in particular, in the event of a hazardous situation, to adjust the path planning and vehicle movement control in order to avoid hazardous situations.

The method allows a vehicle that is driving in an automated manner to analyze a traffic situation lying ahead, in particular a site of a fire flanking the roadway, and to direct the behavior of the vehicle in order to avoid danger to the occupants. Thus this method has the advantage of being able to avoid potentially hazardous traffic situations. Consequently this can drastically increase the safety of the vehicle occupants, especially in regions such as California, Portugal, Spain or Italy that have frequent forest fires.

In a further embodiment of the method, the vehicle is operated on the basis of the output signal such that the vehicle, in the event of the determined danger level exceeding a predefined danger level, is decelerated in such a way that it comes to a stop at a safe distance from the fire.

If the fire is detected in good time, the vehicle can be decelerated smoothly to a stop. If the fire is not detected until very late, an emergency braking maneuver can also be initiated in which the vehicle is stopped as quickly as possible. The safe distance can be saved as a preset in the vehicle in this case.

In another embodiment of the method, the safe distance is determined on the basis of the ascertained or detected fire.

This disclosure has the advantage of allowing a further increase in the safety of the vehicle occupants. Furthermore, it can prevent any unnecessary delays or traffic hold-ups resulting from safety distances that are set too large as standard. In addition, in the event of a rapidly spreading fire, this can prevent unwanted stopping in a position that may potentially become more dangerous.

In another embodiment of the method, in the step of determining the danger level, the danger level is classified into predefined classes.

For example, the classes may be types of fire, for instance vehicle fire, forest fire or building fire. The classes can also be defined, for example, by temperatures of the fires, or the temperature can influence the definition of the class. In addition, the capacity of a fire to spread can influence the classification. Data about the local wind speed and/or wind direction, for example received in the form of environment data, can also be used for this purpose.

In another embodiment of the method, the environment data is obtained using an infrared camera. In this case, the camera has in particular a high sensitivity in the far infrared region.

This embodiment of the method has the advantage that the fire temperature can be determined very quickly and reliably. This can ensure that the danger level of the fire is classified and/or ascertained quickly and reliably.

In another embodiment of the method, a temperature of the fire, in particular a surface temperature of a burning object, is ascertained on the basis of the environment data.

Environment data from an infrared camera can be used for the determination. A temperature of a fire can also be indicated, however, by environment data from other sensors, for instance the colors of the flames, which can be detected using a conventional camera. In addition, sounds that have been obtained by means of microphones can also be analyzed for the purpose of determining temperature. Furthermore, the temperature can be determined on the basis of a classification of the burning object. It is also possible to estimate fire temperatures from the material of the object.

In another embodiment of the method, said method comprises the additional step of sending a signal to an external server and/or a tele-operator if, based on an ascertained or detected fire, a road to be traveled by the vehicle is impassable to the vehicle, and/or, based on the ascertained danger level, the vehicle has been decelerated, and/or is meant to be decelerated, to a standstill.

The sending can be performed by means of an interface present in the vehicle. The signal can be sent either when the vehicle is already at a standstill, or even beforehand if a fire has been detected and, on the basis thereof, a stop procedure is meant to be initiated. In the latter case, the signal is thus sent already before the standstill. This can ensure a smoother traffic flow.

For example, the server, for instance on which a program based on a machine learning technique is running, and/or a tele-operator can determine/ascertain a subsequent driving maneuver. This might include the server or tele-operator ascertaining that the vehicle can still pass the situation and enabling the drive-on clearance for continuing the journey. Alternatively, the server or the tele-operator might establish that the vehicle must turn around and travel an alternative route, and sends corresponding navigation data or a corresponding trajectory to the vehicle.

In addition, a device is claimed that is designed to perform all the steps of a method forming the basis of this application. In particular, the device may be a control unit.

In addition, a computer program is claimed. This computer program comprises commands which, when the computer program is executed by a computer, cause this computer to perform a method according to the disclosure.

A machine-readable storage medium is also claimed, on which said computer program is stored.

### BRIEF DESCRIPTION OF THE DRAWINGS

FIG. 1 shows a schematic method diagram.

FIG. 2 shows another schematic method diagram.

### DETAILED DESCRIPTION

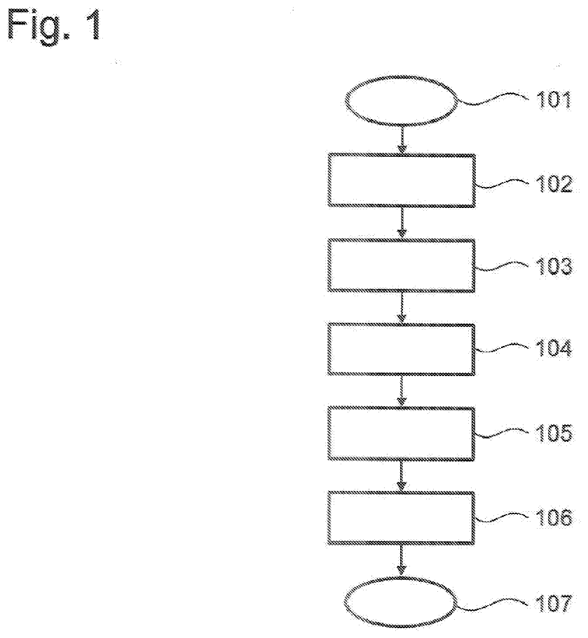

In a first exemplary embodiment, a vehicle operated in a fully automated manner is traveling on a highway. The highway passes through a forested area that is on fire. The vehicle, which is operated in a fully automated manner, has a plurality of sensors, including video sensors, camera sensors, lidar sensors and ultrasonic sensors. In addition, the vehicle is equipped with an infrared camera. The method shown in FIG. 1, which starts in step 101, runs in a control unit of the vehicle.

In step 102, the control unit receives environment data. This data has been acquired by the sensors of the vehicle.

In step 103, a fire is ascertained on the basis of this environment data. It is ascertained in particular on the basis of the received video data. In addition, the temperature of the fire is ascertained by analyzing the environment data from the infrared camera.

In step 104, the distance of the road, and in particular the distance of the planned trajectory, from the fire is ascertained. A check is also performed to ascertain whether the vehicle can be driven along alternative trajectories and whether this increases the distance from the fire. Thus this involves determining the distance of the alternative trajectories from the fire.

In step 105, a danger level representing the danger posed by the fire to the vehicle occupants is determined on the basis of the ascertained distance from the fire. This danger level can vary depending on the distance from the fire and consequently depending on the position of the vehicle and according to the planned and/or controlled trajectory of the vehicle.

In step 106, the control unit outputs a signal for operating the vehicle. In this exemplary embodiment, the fire is still at a distance of 50 m from the road edge. A trajectory is selected that takes the vehicle past the fire on the opposite side from the fire. The vehicle is controlled according to this trajectory.

The method ends in step 107.

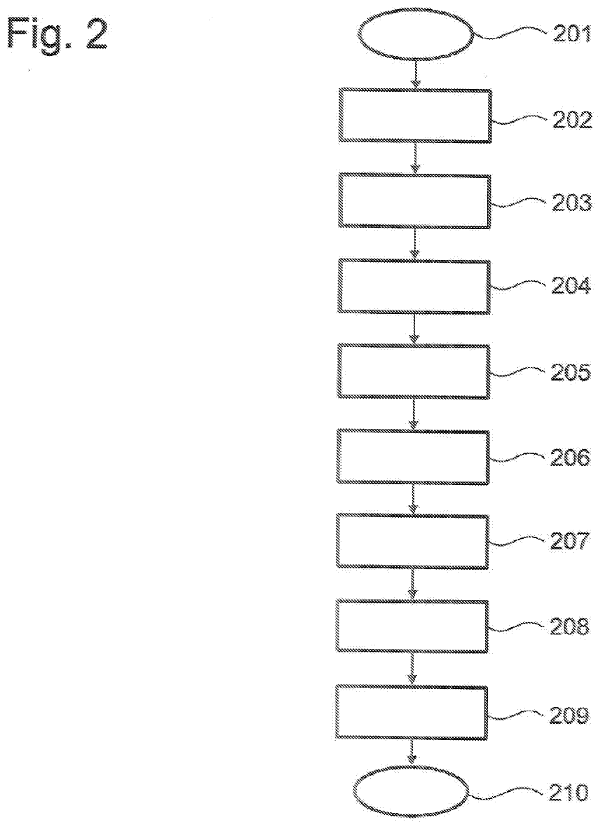

In a another exemplary embodiment, a vehicle operated in a highly automated manner is on a motorway. On the route to be traveled by the vehicle, another vehicle has had an accident and has gone up in flames. The highly automated vehicle is again equipped with its own sensors and also has an interface for receiving external environment data. The method shown schematically in FIG. 2, which starts in step 201, runs in the vehicle.

In step 202, environment data is received in the vehicle. The environment data comprises environment data from the environment sensors of the vehicle. It also comprises additional environment data received from other vehicles via the interface, where in this exemplary embodiment, this additional environment data already contains the information that an accident has happened on the present motorway section.

In step 203, the traffic situation lying ahead is analyzed and a fire is detected on the basis of the received environment data. It is ascertained on the basis of the environment data that the burning object is a vehicle and consequently there is a risk of the temperature rising and possibly of an explosion. The source of the fire is classified on the basis of what is ascertained here. In this process, in particular the data from the imaging sensors is analyzed, for instance by using a neural network to perform semantic annotation of the image pixels.

In step 204, the distance of the planned trajectory from the fire is determined.

In step 205, the danger level of the detected fire load for the occupants should the vehicle pass the relevant location along the planned trajectory is classified.

In step 206, it is determined on the basis of the ascertained fire and the determined danger level whether the vehicle can pass the accident location (or site of the fire). This is done by checking whether the ascertained danger level exceeds a predefined threshold value.

If the predefined threshold value is exceeded, a signal that brings the vehicle to a stop over a comfortable braking distance is output in this exemplary embodiment in step 207. In this process, the vehicle is brought to a stop at a safe distance from the fire. In this exemplary embodiment, the safe distance is determined on the basis of the ascertained fire.

In step 208, a signal comprising information about the present situation and about the fire is sent to an external server and a tele-operating service.

In step 209, on the basis of the sent signal, a control signal is received, which is used for further control of the vehicle.

In this exemplary embodiment, the vehicle is controlled on the basis of the received signal in such a way that it leaves the motorway via an emergency exit.

The method ends in step 210.

What is claimed is:

1. A method for operating an automated vehicle, comprising:
receiving environment data;
determining and/or detecting a fire based on the environment data;
determining a distance of the fire from a road to be traveled by the vehicle and/or from a planned trajectory of the vehicle;
determining a danger level posed by the fire to the vehicle occupants based on the determined distance; and
generating an output signal for operating the vehicle based on the determined danger level.

2. The method according to claim 1, further comprising:
decelerating the vehicle, based on the output signal, such that the vehicle comes to a stop at a safe distance from the fire when the determined danger level exceeds a predefined danger level.

3. The method according to claim 2, wherein the safe distance is determined based on the determined or detected fire.

4. The method according to claim 1, wherein the determination of the danger level includes classifying the danger level into predefined classes.

5. The method according to claim 1, further comprising:
obtaining the environment data using an infrared camera.

6. The method according to claim 1, further comprising:
determining a temperature of the fire, in particular a surface temperature of a burning object, based on the environment data.

7. The method according to claim 1, further comprising:
providing another signal to an external server and/or tele-operator when, based on the determined or detected fire, a road to be traveled by the vehicle is impassable to the vehicle, and/or, based on the determined danger level, the vehicle has been decelerated, and/or is meant to be decelerated, to a standstill.

8. The method according to claim 1, wherein a device is configured to perform steps of the method.

9. The method according to claim 1, wherein a computer program includes commands such that when the computer program is executed by a computer, causes the computer to perform the method.

10. The method according to claim 9, wherein the computer program is stored in a machine-readable storage medium.
